(19) United States
(12) Patent Application Publication
(10) Pub. No.: US 2018/0022931 A1
(43) Pub. Date: Jan. 25, 2018

(54) LOW VOC PEELABLE PAINT SYSTEM AND METHODS

(71) Applicant: THE SHERWIN-WIILIAMS COMPANY, Cleveland, OH (US)

(72) Inventor: Jay A. Reimann, Mentor, OH (US)

(73) Assignee: THE SHERWIN-WILLIAMS COMPANY, CLEVELAND, OH (US)

(21) Appl. No.: 15/218,230

(22) Filed: Jul. 25, 2016

(51) Int. Cl. C09D 5/00; B05C 1/00; B05D 7/00; C09D 133/08; C09D 191/06

(52) U.S. Cl. CPC C09D 5/008; C09D 133/08; C09D 191/06; B05D 7/52; B05C 1/003

(57) ABSTRACT

A paint system having a base coating composition and a top coating composition, each having a low VOC value preferably below 50 g/l, is disclosed. The base coating composition includes a release material and the top coating composition includes a pigment and a paint emulsion. The base coat formulation is applied to a surface to form a base coating and the top coat layer is applied over the top coating. When dry, the top coating has high cohesion relative to the adhesion of top coating to base coating, thereby permitting the top coating to be manually peeled away from the surface. Related methods are also disclosed.

### TECHNICAL FIELD

The disclosure relates generally to coating compositions such as paints, and specifically to peelable paint composition, systems, and methods.

### BACKGROUND

Paints are applied to surfaces for decorative and protective purpose. Paints typically contain four classes of ingredients: carrier liquid, binder, pigment, and additives, although in multi-stage paint systems not all of these components are present in each stage. Each of such ingredient classes may comprise a single component, or the ingredient class may comprise several different items mixed into the paint.

The carrier liquid is a fluid component of the paint which serves to carry all of the other paint components. The carrier liquid is part of the wet paint and usually evaporates as the paint forms a coating and dries on a surface. In latex paints, the carrier liquid is usually water. In oil-based paints, the carrier liquid is usually an organic solvent. The amount and type of liquid is usually determined by features of the other paint components.

The binder component of a paint is what causes the paint to form an adhering film or coating on a surface. In a latex paint, the binder comprises a latex resin, usually selected from acrylics, vinyl acrylics, or styrene acrylics. In a latex paint, the latex resin particles usually are in a dispersion with water as the carrier liquid.

Pigments are provided to impart both decorative and protective features to the paint. Pigments are solid particles used to provide the paint with various qualities, including but not limited to color, opacity, and durability. The paint may also contain other solid particles such as polyurethane beads or other solids. Pigments and other solids add bulk to the paint and their levels are related to the gloss or flatness of the paint.

A multitude of additives may be included in paints. The additives are typically used at relatively low levels in the paint formulation, but contribute to various properties of paints, including rheology, stability, paint performance, and application quality.

It is desirable in some instances to provide a peelable paint formulation or system. Such a system allows the user to apply a temporary coating of paint, and to remove the paint coating when desired, for example, to create a temporary mural on a wall or window or to temporarily change the color of a wall surface. There exist a number of removable paint systems, but many such systems are useful only on non-porous surfaces and are indelible on porous surfaces. Additionally, for environmental reasons, it is desirable to provide paints that have a VOC value of less than 100 g/L, preferably lower than 50 g/L, and more preferably less than 25 g/L. This is particularly true of interior paints and especially true for residential paints intended for homeowner application.

### SUMMARY

It has not been found that a low VOC paint system that allows for a peelable paint coating over porous wall surfaces may be provided. The paint system comprises a base coating composition and a top coating composition. The base coating composition comprises a release material and has a VOC value less than 100 g/l, and preferably less than 50 g/L. The top coating composition comprises a pigment and an emulsion paint base, and likewise has a VOC less than 100 g/l, and preferably less than 50 g/L. The base coat dries to form a base coating and the top coating composition dries to form a top coating. When applied over the base coating, the top coating composition dries to produce a top coating that has sufficient cohesion relative to the adhesion of said top coating over said base coating to allow manual peeling of said top coating from said base coating. The release material in the base coating may be, for example, PTFE or paraffin wax, and the emulsion paint base may comprise an acrylic latex emulsion that dries to a film having a tensile strength greater than 1800 PSI for the applied film and a peak elongation greater than 600% as is measured by ASTM D638 for Type IV Geometry. In some embodiments, the invention encompasses a coated surface comprising a wall surface and base and top coatings as described herein.

In some embodiments, not mutually exclusive with regard to one another or to the heretofore-described embodiments, the invention encompasses one or more methods. In one aspect, a method includes applying a base coating composition to a wall surface, allowing the base coating composition to dry to form a base coating, and applying said top coating composition over said base coating, optionally with an overlaying third coating composition. Another method includes approaching a wall surface coated with a base coating and a top coating, and manually peeling the top coating away from the wall surface. Another method includes approaching a wall surface coated with a base coating and a top coating, and applying an overlaying third coating composition over said top coating. Another method includes approaching a wall surface coated with a base coating and a top coating and an overlaying third coating and removing the top coating and overlaying third coating by peeling. The person or entity that applies the overlaying coating or that remove the coatings by peeling may be independent from the entity that apply the coating compositions, and both may be independent from the entity who manufactures the paint system. In another aspect, the invention encompasses a surface, such as a porous surface, coated with a base coating and a top coating, and optionally an overlaying coating.

### BRIEF DESCRIPTION OF THE DRAWING

FIG. 1 is a perspective view of a top coating being peeled away from a wall surface coated with a base coating.

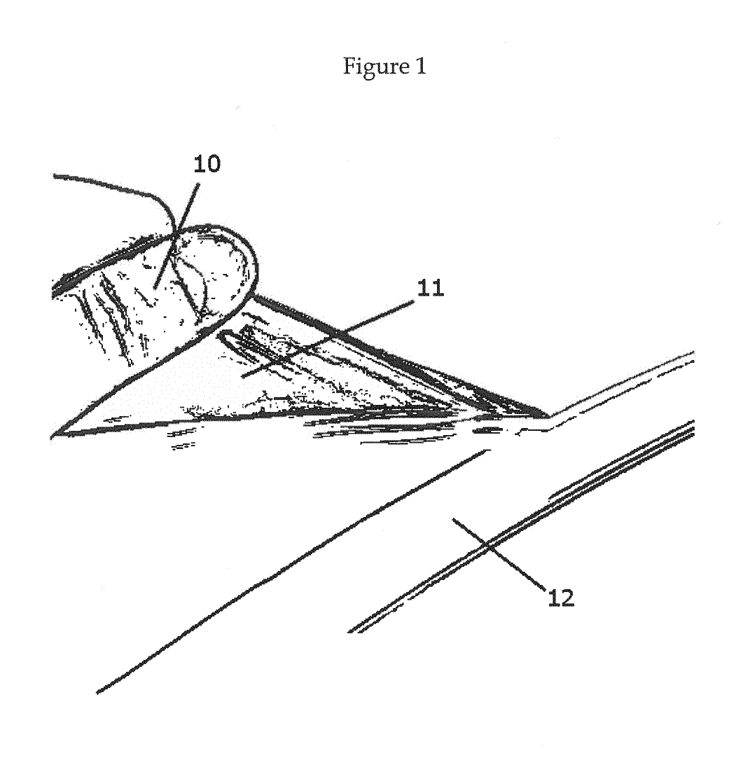

FIG. 2 is a series of photographs of a top coating being peeled away from a wall surface coated with a base coating.

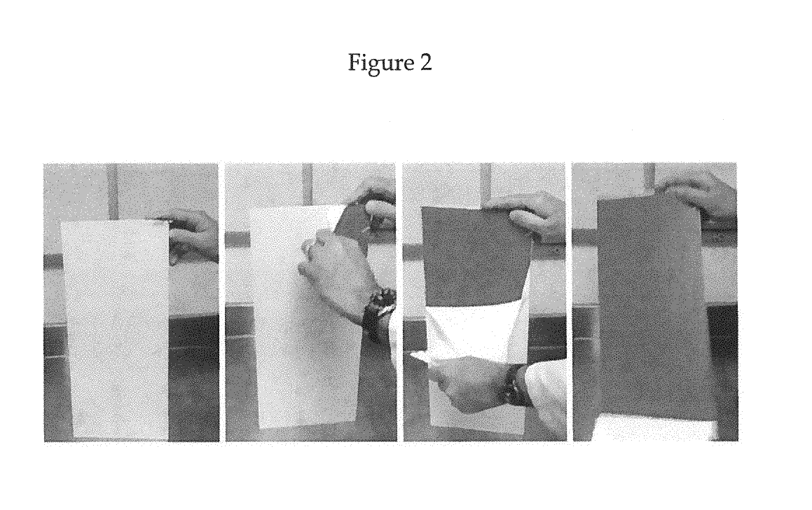

### DETAILED DESCRIPTION

The paint system generally allows for the application of a base coating composition onto a surface, such as wood or another porous surface, which then dries to form a base coating. Subsequently, a top coating composition is applied, and this top coating composition dries to form a top coating. It is intended that the top coating is highly cohesive relative to the adhesion between the top and base coating to thereby allow the top coating to be peeled away from the underlying surface. It is contemplated that some of the base coating may in fact adhere to the top coating when the top coating is removed; this is permissible within the context of the disclosure, so long as the top coating may be at least substantially completely removable by one or more peeling actions. As seen in the Figure, for example, the user's hand 10 has manually grasped the top coating 11 to peel the top coating away from the underlying surface 12. A brush, roller, sponge, or other painting tool may be used to apply either coating composition.

After removal of the top coating, it may be possible to add an overlaying third coating composition without the necessity of applying additional base coating composition onto the underlying surface. In such case, the overlaying coating composition will dry to form an overlaying coating. This third overlaying coating will be peelably removable from the surface because it is adhered to the top coating. The overlaying coating may be a colored coating composition, or it may be a specialty coating composition such as a textured coating composition, a dry-erase coating composition, or a chalkboard paint coating composition. For instance, a textured coating composition may be used to form a textured surface, and this textured surface may be removed when desired without the necessity of sanding or wall replacement. More generally, the overlaying coating composition may be any suitable coating composition. Such coating composition may include any suitable carrier liquid, binder, pigment, and additives as may be known or found useful.

The base coating composition and the top coating composition and any overlaying coating composition each are formed using a carrier liquid. Because of the desirability of providing compositions with low levels of volatile organic compounds (low VOC levels), it is highly preferred that the carrier liquid in each case is primarily or water. It is contemplated that other carrier liquids may be found to be suitable. The technology described herein could be employed with organic carrier liquids if VOC levels were not of concern. Determination of volatile organic carrier levels may be made in any suitable fashion; equipment for use in such determination is described in U.S. Pat. No. 8,868,224, assigned to The Sherwin-Williams Company of Cleveland, Ohio and incorporated by reference in its entirety. Because the carrier liquid is subject to drying, normally each coating composition should be supplied in a separate sealed container. The paint system may comprise the base coating composition and the top coating composition and optionally may comprise one or more additional overlaying compositions.

The base coating composition is formulated with a release material. The release material is a material that, in cooperation with the dried top coating, allows for manual removal of the top coating from the underlying surface. It is generally contemplated that the release material is included in sufficient quantity such that the adhesive force adhering the top coating to the base coating is not as strong as the internal cohesive force of the top coating, such that the a manual peeling force may be applied to remove the top coating. Additionally, when used on a porous surface, the release agent should be employed to lower the interfacial surface energy of the porous surface. Any suitable material may be employed for this purpose, and exemplary materials include polytetrafluoroethylene (PTFE) and paraffin wax, and mixtures thereof. Polyisoprene rubber also may be employed. The release material may be present in any amounts suitable for this purpose.

At least the top coating composition includes a binder polymer, and the base coating composition may optionally include a binder polymer as well. In either case, the binder polymer may be selected from any film-forming polymer useful in coatings applications as are known or which may become known to those skilled in the art, with the proviso that in the top coat formulation the paint emulsion must be suitable to produce a top coating having sufficient cohesion relative to the adhesion of said top coating over said base coating to allow manual peeling of said top coating from said base coating.

Generally, the top coating composition includes a binder to achieve the result that, when the top coating composition is applied over the dried base coating, the top coating composition dries to produce a top coating having sufficient cohesion relative to the adhesion of the top coating over the base coating to allow manual peeling of the top coating from the base coating. “Manual peeling” includes cases where a tool is used to start the peeling process. It is contemplated that any suitable binder may be used that achieves this result. While a variation in components and amounts is contemplated, in general it is preferred that the binder is an acrylic latex emulsion and that this emulsion dries to a film having a tensile strength greater than 1800 PSI and a peak elongation greater than 600% One such binder is CARBOSET PL958, available from The Lubrizol Co. of Wickliffe, Ohio. Another nonlimiting example of such a binder is CARBOSET 441, also available from The Lubrizol Co. of Wickliffe, Ohio. Other binders that may be suitable are Yulex Guayule (natural rubber) which is available from the Yulex Corporation of Chandler, Ariz. and Kraton Cariflex (polyisoprene rubber) which is available from Kraton Performance Polymers, Inc. of Houston, Tex. It is believed that the tensile strength of the dried resin is approximately 2100 PSI and the peak elongation is approximately 670% also as measured by ASTM D638 for Type IV Geometry. It is also contemplated to use other resins that do not meet these values. In some cases, more typical binders will coat the base coating but may be less durable than desired. A primer coating may be placed over the base coating to increase durability.

If found to be suitable, other binder resins may be used in the top coating composition, and if an overlaying third coating composition is provided, the coating composition may include one or more conventional binders. Generally, the binder resin is preferably waterborne and more preferably one or more latex polymers formed by emulsion polymerization of at least one ethylenically unsaturated monomer in water using surfactants and water soluble initiators. Typical ethylenically unsaturated monomers include vinyl monomers, acrylic monomers, acid-functional monomers, allylic monomers and acrylamide monomers. For architectural applications, the binder resin(s) is/are preferably formed from vinyl monomers and/or acrylic monomers. Suitable vinyl monomers include vinyl esters, vinyl aromatic hydrocarbons, vinyl aliphatic hydrocarbons, vinyl alkyl ethers and mixtures thereof. Examples of vinyl esters that may be used include vinyl acetate, vinyl propionate, vinyl laurate, vinyl pivalate, vinyl nonanoate, vinyl decanoate, vinyl neodecanoate, vinyl butyrates, vinyl benzoates, and vinyl isopropyl acetates. Examples of vinyl aromatic hydrocarbons that may be used include styrene, methyl styrenes and other lower alkyl styrenes, chlorostyrene, vinyl toluene, vinyl naphthalene and divinyl benzene. Examples of vinyl aliphatic hydrocarbons that may be used include vinyl chloride and vinylidene chloride as well as alpha olefins such as ethylene, propylene, isobutylene, as well as conjugated dienes such as 1,3 butadiene, methyl-2-butadiene, 1,3-piperylene, 2,3-dimethyl butadiene, isoprene, cyclohexene, cyclopentadiene, and dicyclopentadiene. Examples of vinyl alkyl ethers that may be used include methyl vinyl ether, isopropyl vinyl ether, n-butyl vinyl ether, and isobutyl vinyl ether. Acrylic monomers suitable for use in the present invention include any compounds having acrylic functionality, such as alkyl (meth)acrylates, acrylic acids, as well as aromatic derivatives of (meth)acrylic acid, acrylamides and acrylonitrile. Typically, the alkyl (meth)acrylate monomers (also referred to herein as “alkyl esters of (meth)acrylic acid”) will have an alkyl ester portion containing from 1 to 12, preferably about 1 to 5, carbon atoms per molecule. Suitable acrylic monomers include, for example, methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate and various reaction products such as butyl, phenyl, and cresyl glycidyl ethers reacted with (meth)acrylic acid, hydroxyl alkyl (meth)acrylates, such as hydroxyethyl and hydroxypropyl (meth)acrylates, amino (meth)acrylates, as well as acrylic acids such as (meth)acrylic acid, ethacrylic acid, alpha-chloroacrylic acid, alpha-cycanoacrylic acid, crotonic acid, beta-acryloxy propionic acid, and beta-styryl acrylic acid. The binder resin(s) may be prepared using any of the well-known free-radical emulsion polymerization techniques used to formulate latex polymers. Polymerization techniques suitable for use herein are taught in U.S. Pat. No. 5,486,576, which is incorporated herein by reference.

The binder may include a latex polymer emulsion. Conventional latex emulsions include those prepared by polymerizing at least one ethylenically unsaturated monomer in water using surfactants and water soluble initiators. Typical ethylenically unsaturated monomers include vinyl monomers, acrylic monomers, allylic monomers, acrylamide monomers and mono- and dicarboxylic unsaturated acids. Vinyl esters include vinyl acetate, vinyl propionate, vinyl butyrates, vinyl isopropyl acetates, vinyl neodeconate and similar vinyl esters; vinyl halides include vinyl chloride, vinyl fluoride and vinylidene chloride; vinyl aromatic hydrocarbons include styrene, .alpha.-methyl styrene, and similar lower alkyl styrenes, Acrylic monomers include monomers such as lower alkyl esters of acrylic or methacrylic acid having an alkyl ester portion containing between 1 to 12 carbon atoms as well as aromatic derivatives or acrylic and methacrylic acid. Useful acrylic monomers include, for example, acrylic and methacrylic acid, methyl acrylate, and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecylacrylate and methacrylate, and benzyl acrylate and methacrylate.

Preparation of latex compositions is well-known in the paint and coatings art. Any of the well-known free-radical emulsion polymerization techniques used to formulate latex polymer can be used in the present invention. Polymerization techniques suitable for preparing polymers useful in the present invention are taught in U.S. Pat. No. 5,486,576, which is hereby incorporated by reference.

Any suitable pigment may be employed in the top coating composition or in an overlaying coating composition. The base coating composition likewise may include a pigment or it may not be formulated with a pigment. When used, the pigment may be present in any suitable amount, typically at least about 10% by weight pigments. Such pigments may comprise inorganic pigments, such as titanium dioxide. When used, the top coating composition may comprise, for example, at least about 11% by weight, further for example, at least about 12% by weight, further for example, at least about 13% by weight, further for example, at least about 14% by weight, further for example at least about 15% by weight, further for example, at least about 16%, further for example at least about 17%, further for example, at least about 18%, further for example at least about 19%, and even further for example at least about 20% up to about 30% by weight titanium dioxide.

Other colored pigments or dyes may also be added to the paint, alone or in combination, to produce a wide range of paint colors. Suitable additional pigments may include calcium carbonate, talc, clay, silicates, aluminum silicates, calcium metasilicates, aluminum potassium silicates, magnesium silicates, barium sulfates, nepheline syenite, feldspar, zinc oxides or sulfides, or others known to those skilled in the art. Such additional colored pigments may be included in amounts up to about 30% by weight, for example, about 10% to about 20%. In some cases, “pigments” may also refer to functional fillers which are non-water soluble solids. Such functional fillers may include solids which provide additional functional characteristics to the paint, for example, intumescent ingredients, such as ammonium polyphosphates, melamines, pentaerythritol and similar compounds. In one useful embodiment, the coating composition of the present invention is substantially free or totally free of intumescent ingredients such as ammonium polyphosphates, melamines, and pentaerythritol and similar compounds.

The pigment volume concentration, or PVC, of a coating composition is the ratio of the volume of pigments (including functional fillers) to the volume of total non-volatile material (i.e. pigment and binder) present in the coating. The top coating composition preferably has a PVC of about 5 to about 60. In addition, the coating composition of the present invention has a maximum solids content of less than 65% by weight, for example, about 25% by weight to about 60% by weight, further for example about 30% by weight to about 58% by weight.

The top coating composition, base coating composition, and any overlaying third coating composition generally will include one or more additives, which are added in suitable amounts for their intended purposes. Suitable additives include known paint additive materials, including for example to thickeners, such as urethane thickeners, and acrylic thickeners in amounts up to about 10% by weight, for example about 1% to about 2%; pigment dispersing agents which can be solvents or surfactants; and anti-settling agents. One or more of the compositions can include biocides/preservatives, such as metal ion containing compounds, polymeric biocides, heterocyclic compounds, phenols, organometallics, aldehydes, proteins, peroxygens, alcohols, enzymes, polypeptides, and halogen releasing compounds. The compositions may include coalescing agents; plasticizers; stabilizers; viscosifiers; leveling aids; defoamers such as oils, fatty acids and silicones; slip and mar additives; adhesion promoters; anti-skinning agents; extenders; crosslinkers; corrosion inhibitors; or other suitable paint additives. Synthetic organic materials might also be incorporated; these include plastic beads, hollow spheres or other similar materials. Other optional components include glycols such as ethylene and/or propylene glycol in amounts up to about 7% and other solvents such as diethylene glycol dibenzoate and dipropylene glycol dibenzoate in amounts up to about 3%.

The top coating composition may dry to form a top coating having any suitable or attainable gloss value. Gloss is typically evaluated using one or more glossmeters, and gloss values range from 0 to 100 with 100 being the highest value. High-gloss finishes typically have a gloss value of 70 through 100; semi-gloss finishes have a gloss value ranging from 10 and 70; and flat finishes have a gloss value from 0 through 10. The top coating compositions generally can attain a semi-gloss or high-gloss finish and it is contemplated that a flat finish may be attainable. Paints with higher pigment volume concentration, coinciding with flatter finishes, tend to have lower tensile strength and peak elongation. Polymeric matting agents or ingredients such as tapioca or other starches may be used to impart flexibility to the pigment if a lower gloss value is desired.

The top coating composition may have an NVV (non volatile volume) of greater than 20% by weight. In other embodiments, the top coating may have an NVV of greater than 30% by weight. The top coating composition may have an NVV of from about 20% to about 50% by weight, and in other embodiments, may have an NVV of from about 30% to about 40% by weight.

### EXAMPLE

### Example 1: Base Coating Composition Specification

| | |
|---|---|
| 65-85 | weight % by water |
| 10-30 | weight % paraffin |
| 0-5 | weight % HEUR thickener¹ |
| 0-1 | weight % HEC thickener² |
| 0-0.1 | weight % O-cresolphtalein hydrochromic pigment; |
| 0-2 | weight % mineral oil defoamer, |
| 0-1 | weight % nonionic surfactant |

¹hydrophobically modified ethoxylated urethane
²hydroxyethylcellulose

### Example 2: Top Coating Composition Specification

| | |
|---|---|
| 50-60 | weight % by water |
| 25-30 | weight % PL958 latex solids as a binder |
| 11-13 | weight % pigment |
| 4-6 | weight % POGOL 600 (hemectant)³ |
| 0-1 | weight % AIRASE 5100 (defoamer)⁴ |
| 0-1 | weight % PATCOTE 519 (defoamer)⁵ |
| 0-1 | weight % PROXEL BD20 (biocide)⁶ |
| 0-1 | weight % TAMOL 731A (dispersant)⁷ |
| 0-1 | weight % DYNOL 360 (surfactant)⁸ |
| 0-2 | weight % ACRYSOL TT935 HASE (thickener)⁹ |

³polyethylene glycol from Huntsman Corp. of The Woodlands, TX
⁴polyether siloxane from Air Products and Chemicals, Inc. of Allentown, PA
⁵from Hydrite Chemical Co. of Brookfield, Wisconsin
⁶1,2-Benzisothiazolin-3-one from Lonza of Basel, Switzerland
⁷from Dow Corp. of Midland, MI
⁸from Air Products and Chemicals, Inc. of Allentown, PA
⁹hydrophobically modified acrylic thickener from Dow Coating Materials of Midland, MI

### Example 3: Paint System

A paint system comprising the following base coating composition and to coating composition was prepared. The coating compositions were placed in separate containers.

### Base Coating Composition

| | |
|---|---|
| 77 | weight % water |
| 16 | weight % paraffin |
| 4.8 | weight % HEUR thickener |
| 0.6 | weight % HEC thickener |
| 0.1 | weight % O-cresolphtalein |
| | hydrochromic pigment; |
| 0.48 | weight % mineral oil |
| 0.24 | weight % nonionic surfactant |

### Top Coating Composition

| | |
|---|---|
| 57.29 | weight % by water |
| 28.1 | weight % PL958 latex solids as a binder |
| 12 | weight % pigment comprising 4.17 weight % MINUGEL, |
| | 50 weight % tapioca starch; and 45.83 weight % TiO2; |
| 2.2 | weight % POGOL 600 polyethylene glycol |
| 0.3 | weight % AIRASE 5100 polyether siloxane |
| 0.3 | weight % PATCOTE 519 |
| 0.3 | weight % PROXEL BD20 |
| 0.15 | weight % TAMOL 731A |
| 0.15 | weight % DYNOL 360 |
| 1.1 | weight % ACRYSOL TT935 HASE |

The top coating composition was applied to a dried base coating and dried to form a painted surface. Upon drying, the top coating was manually peelable from the base coating.

### Example 4: Peeling Method

A user approaches a porous wall surface that has been coated with a base coating and top coating that have been prepared and applied using the paint system of Example 3. The user manually peels the base coating away from the wall surface.

### Example 4: Overlaying Coating

A user approaches a wall surface that has been coated with a base coating and top coating that have been prepared and applied using the paint system of Example 3. The user applies a textured overlaying third coating composition

### Example 5: Peeling of Overlaying Coating

A user approaching a wall surface that has been coated with a base coating and top coating that have been prepared and applied using the paint system of Example 3, and to which an overlaying coating was subsequently applied. The user removes the top coating and overlaying third coating by peeling.

It is thus seen that a peelable paint system may be provided via the teachings herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A paint system comprising:
a base coating composition and a top coating composition, said base coating composition comprising a release material, said base coating composition having a VOC value less than 50 g/L, said top coating composition comprising a pigment and an emulsion paint base, said top coating composition having a VOC less than 50 g/L;
said base coating composition dying to form a base coating;
said top coating composition, when applied over said base coating, drying to produce a top coating having sufficient cohesion relative to the adhesion of said top coating over said base coating to allow manual peeling of said top coating from said base coating.

2. A system according to claim 1, said base coating composition and said top coating composition each being aqueous and each having a VOC value less than 25 g/L.

3. A system according to claim 1, said top coating comprising an acrylic latex emulsion paint base.

4. A system according to claim 3, said acrylic latex emulsion drying to a film having a tensile strength greater than 300 PSI and a peak elongation greater than 600%.

5. A system according to claim 1, said release material being selected from the group concerning of PTFE, paraffin wax, and mixtures thereof.

6. A system according to claim 1, said release material comprising paraffin wax.

7. A method comprising:
providing a paint system, said paint system comprising:
a base coating composition and a top coating composition, said base coating composition comprising a release material, said base coating composition having a VOC value less than 50 g/L, said top coating composition comprising a pigment and an emulsion paint base, said top coating composition having a VOC less than 50 g/L;
said base coating composition dying to form a base coating;
said top coating composition, when applied over said base coating, drying to produce a top coating having sufficient cohesion relative to the adhesion of said top coating over said base coating to allow manual peeling of said top coating from said base coating;
applying said base coating composition to a wall surface;
allowing said base coating composition to dry to form a base coating;
applying said top coating composition over said base coating.

8. A method according to claim 7, said base coating composition and said top coating composition each being aqueous and each having a VOC value less than 25 g/L.

9. A method according to claim 7, said top coating comprising an acrylic latex emulsion.

10. A method according to claim 9, said acrylic latex emulsion drying to a film having a tensile strength greater than 1800 PSI and a peak elongation greater than 600%.

11. A method according to claim 7, said release material being selected from the group concerning of PTFE, paraffin wax, and mixtures thereof.

12. A method according to claim 7, further comprising applying an overlaying coating composition after drying of said top coating composition.

13. A method according to claim 7, said release material comprising paraffin wax.

14. A method comprising:
approaching a wall surface coated with a base coating and a top coating, the base coating having been dried from a base coating composition comprising a release material, and having a VOC value less than 50 g/L; said top coat having been dried from a top coating composition comprising a pigment and an emulsion paint base and a VOC less than 50 g/L, said top coating having sufficient cohesion relative to the adhesion of said top coating over said base coating to allow manual peeling of said top coating from said base coating; and
manually peeling said top coating from said wall surface.

15. A method according to claim 14, said top coating comprising an acrylic latex emulsion.

16. A method according to claim 14, said release material being selected from the group concerning of PTFE, paraffin wax, and mixtures thereof.

17. A method according to claim 14, said release material comprising paraffin wax.

18. A method comprising:
approaching a wall surface coated with a base coating and a top coating, the base coating having been dried from a base coating composition comprising a release material, and having a VOC value less than 50 g/L; said top coat having been dried from a top coating composition comprising a pigment and an emulsion paint base and a VOC less than 50 g/L, said top coating having sufficient cohesion relative to the adhesion of said top coating over said base coating to allow manual peeling of said top coating from said base coating; and
applying an overlaying third coating composition over said top coating.

19. A painted surface comprising:
a wall surface;
a base coating disposed over the wall surface; and
a top coating disposed over the base coating;
the base coating having been dried from a base coating composition comprising a release material, and having a VOC value less than 50 g/L; said top coat having been dried from a top coating composition comprising a pigment and an emulsion paint base and a VOC less than 50 g/L, said top coating having sufficient cohesion relative to the adhesion of said top coating over said base coating to allow manual peeling of said top coating from said base coating
